(19) United States
(12) Patent Application Publication
(10) Pub. No.: US 2010/0200794 A1
(43) Pub. Date: Aug. 12, 2010

(54) METHOD FOR PRODUCING AN ABSORBER FOR MICROWAVES AND ABSORBER PRODUCED ACCORDING TO THE METHOD

(76) Inventor: Hans-Dieter Cornelius, Dresden (DE)

Correspondence Address: JACOBSON HOLMAN PLLC, 400 SEVENTH STREET N.W., SUITE 600, WASHINGTON, DC, 20004, US

(21) Appl. No.: 12/452,906

(22) PCT Filed: Jul. 28, 2008
(86) PCT No.: PCT/DE2008/001282

§ 371 Date: Apr. 19, 2010

(30) Foreign Application Priority Data
Jul. 28, 2007 (DE) 2007035560.4

(51) Int. Cl. E04B 1/74; H01F 1/00; B29C 70/42

(52) U.S. Cl. 252/62; 252/62.54; 264/83

(57) ABSTRACT

The invention concerns a method for production of an absorber for microwaves, consisting of a packing of expanded polystyrene elements (EPS elements), on which a coating of ferrimagnetic particles is applied, and an absorber produced accordingly. According to the method, an enclosure of synthetic polymers formed on the EPS elements and a polymer matrix, in which the ferrimagnetic particles are embedded, is applied. The coated EPS elements are introduced to a mold and a water vapor stream introduced. The EPS elements expand through the vapor pressure of the residual fraction of pentane in the EPS elements and assume their final size and shape.

The absorber produced with the method consists of a packing of EPS elements, which are coated with a ferrimagnetic powder within a polymer matrix, and whose outer structure corresponds to a processing mold.

The invention concerns a method for production of an absorber for microwaves according to the preamble of claim 1 and an absorber produced accordingly for microwaves with a wide bandwidth (1-100 GHz). Such absorbers can be used advantageously anywhere reflection coefficients of >20 dB are also required in the far field without transmission. This is then a quasi-closed-cell foam absorber, with which flat surface forms can also be implemented.

### PRIOR ART

According to the prior art, different solutions are known for absorption of microwaves. For example, DE 296 21 804 U1 describes a radiation-absorbing material, consisting of a fine-grained component, for example, a polymer, glass, rock or ceramic, with limited density and an electrically conducting component, which are bonded with a binder. The fine-grained component can have expanded polystyrene grains.

### STATEMENT OF THE TASK

The underlying task of the invention is to offer a method for production of an absorber for microwaves, consisting of a packing of elements made of expanded polystyrene, subsequently referred to as EPS elements, on which a coating of ferrimagnetic material is applied, with which a reflection coefficient of >20 dB is achieved without transmission and the evaluable radar cross section therefore remains small. An absorber for microwaves is also to be provided, which is produced with a method according to the invention.

The invention solves the task for the method by the features stated in claim 1. The task for an absorber is solved by the features of claim 6. Advantageous modifications of the invention are characterized in the dependent claims and are further presented below, together with the description of the preferred variant of the invention, including the drawing.

The absorber for microwaves is constructed from a packing of EPS elements, on which a coating of ferrimagnetic material is applied. The EPS elements have the advantage that the transmission-inhibiting effect caused by the material-dependent low dielectric constant of polystyrene and the very small weight-volume ratio caused by expansion of polystyrene are negligibly small and therefore practically transparent for microwaves.

In a packing of EPS elements coated with a ferrimagnetic material, the evaluable radar cross-section is reduced according to the invention for the following reasons. The first reason is that the packing has a large number of walls made of ferrimagnetic material, and at frequencies of <15 GHz, the penetration depth is still large enough, that a number of spheres of correspondingly limited layer thicknesses are traversed by the microwaves and fractional damping of the microwaves by diffuse reflection therefore occurs on the interface transitions from ferrimagnetic material to EPS elements, which ultimately leads to absorption of microwaves. In addition, the absorbent ferrimagnetic material is distributed as a foam-like absorption surface over the entire volume of the packing. The number of EPS elements is then chosen as large as possible. The second reason for reduction of the evaluable radar cross section is present, when the relief of the exposed packing surface is formed by caps of spherical EPS elements. Such a packing surface is formed when the spherical EPS elements are arranged as a hexagonally packed monolayer. The packing surface is then two-times larger relative to flat surface structures and increases the absorption capacity even at frequencies of >15 GHz, where absorption occurs almost exclusively in the near-surface regions, because of the diminishing penetration depth. The drawback of the enlarged reflection surface is then insignificant, since the spherical cap-like shape initiates a diffuse reflection and therefore the evaluable radar cross section remains small. Diffuse reflection remains constant with incident radiation within an azimuth of 170°, caused by the spherical cap shape. The diameter of the coated spherical EPS elements is then adapted accordingly as a function of wavelength, in order to initiate diffuse reflection.

If the thickness of the packing is limited because of the application, the still present transmission of microwaves through the packing can be prevented by a metal protective film insulated relative to the EPS elements on the side facing away from the incoming rays. The microwaves reflected in the protective film are then absorbed on passing through the packing in the opposite direction.

According to the method, the absorber is produced by selecting EPS elements with a residual fraction of pentane. The EPS elements are enclosed with a polymer, so that diffusion of pentane from the EPS elements is hampered at temperatures lower than 100° C. A mixture of a polymer matrix and a ferrimagnetic powder is applied as coating of ferrimagnetic material. The EPS elements coated in this way are introduced to a process stipulated mold and exposed in the mold to a water vapor stream with a temperature above 100° C. until the residual fraction of pentane is evaporated and the EPS elements are inflated. Depending on the employed polymer matrix according to claim 3, this is dissolved again either by the water vapor or softens as a result of heat input, both effects ultimately leading to gluing together of the coated EPS elements. By inflation of the coated EPS elements, the open porosity is eliminated, the adhesive surface enlarged and additional adhesive is therefore avoided. This solution is particularly advantageous, since any additional adhesive fraction reduces the penetration capacity of the microwaves.

EPS elements with a diameter from 0.5 to 10 mm are chosen. The sphere diameters within the packing are then chosen differently, so that the maximum possible number of spheres per unit volume is present.

Particles of metal oxide solids are used as ferrimagnetic material, which have small coercivity field intensities at high initial permeabilities. This condition is present independently of particle size in soft magnetic, crystalline materials, like spinels, from Mn—Zn ferrite. The particle size is determined by the coating process and should be <5 μm during spraying in conjunction with the aqueous dispersion from copolymers. Metal oxide solids with hexagonal lattice structure, for example, Sr- or Ba-ferrite, have unduly high coercive field intensities relative to spinels and are not excited as energetically by the incoming electromagnetic wave in the far field, i.e., at radiation energies of about 10 mW, so that magnetic reversal can occur. These ferrites, for example, Sr-ferrite as M-type, therefore must be reduced by grinding to a particle size of <500 nm and only then do they reach coercive field intensities of <50 kA/m, i.e., similar to the values of soft magnetic materials. These ground hexagonal ferrites are mostly used in absorbers for frequencies of >15 GHz, since, relative to spinels, the required frequency-dependent permeability is still large enough.

The selective particles of ferrimagnetic material are generally powdered and have an average size of 200 nm to 5 μm diameter, depending on the described applications.

The ferrimagnetic particles are embedded in a polymer matrix. The polymer matrix not only glues the particles to each other, but also prevents direct surface contact between particles from being restricted as a result of agglomerate formation. Depending on the complex resistance of the employed ferrimagnetic particles, the conductivity of the polymer is adjusted by adding carbon particles, for example, carbon black.

The EPS elements are spray-coated before coating with the polymer matrix with an aqueous polyvinyl alcohol solution and dried in an air stream at 60° C. The film coating so formed serves as an additional barrier and prevents premature diffusion of pentane from the EPS elements.

For the polymer matrix, during use of spinel ferrites for example, Mn—Zn-ferrite, polyvinyl acetate, which has an aqueous dispersions as pH values of ≦7, has worked, to which a polyisocyanate cross-linking agent can be additionally added. On the other hand, during use of hexagonal ferrites, for example, Sr-ferrite as M-type, a polymer matrix of styrene-butadiene copolymers or acrylic acid ester-styrene copolymers is necessary. The aqueous dispersions of styrene-butadiene copolymers have dispersants with pH values >7 and restrict formation of Sr-ions through the OH-ion excess. In addition, their use is also useful, since these copolymers, relative to polyvinyl acetate, have lower dielectric constant, which is an advantage at frequencies of >15 GHz connected with the lower penetration depth.

The absorbers produced according to the method consist of a packing of EPS elements coated with a ferrimagnetic powder within a polymer matrix, which corresponds to the outer structure of a processing mold.

The absorber can exhibit a lattice support or tubular honeycombs, in which the coated EPS elements are glued in at least one monolayer

The absorber from packed coated EPS elements or this constructed as a monolayer in flat lattices with a coating of particles of ferrimagnetic material possesses in a wide band region (1-100 GHz) for microwaves a high absorption capacity and constructed as a monolayer additionally have diffuse reflection properties that reduce the evaluable radar cross section. The packed coating EPS elements have limited weight, low heat conductivity, and also high sound absorption capacity. The product “absorber for microwaves” with these properties can also be advantageously produced and used for other end products. The absorber according to claim 8 is an element for reduction of the weight and heat conductivity of for an increase in sound absorption capacity of an end product.

### PRACTICAL EXAMPLES

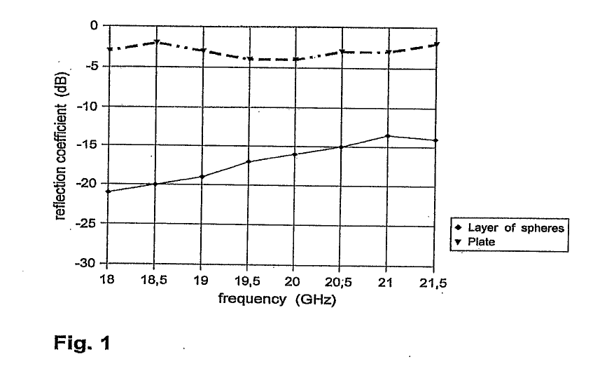

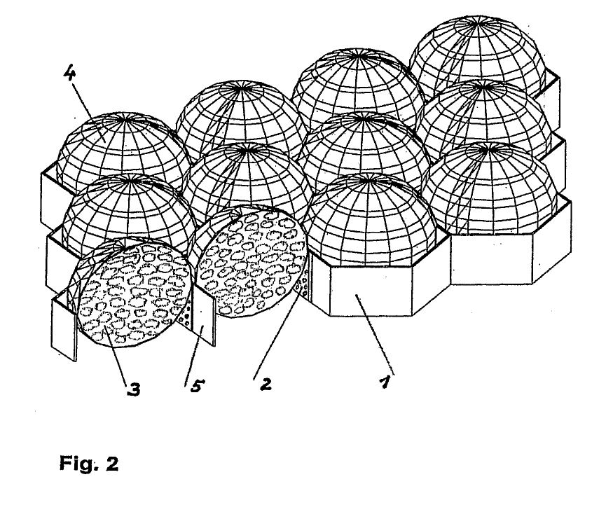

The invention is further explained below with two practical examples. FIG. 1 shows a diagram with the reflection coefficient as a function of frequency. Relative to practical example II, FIG. 2 shows a perspective section through an absorber produced according to the invention.

### Practical Example I

In practical example I, the method according to the invention for production of absorber for microwaves <15 GHz is further described, in which the absorber is supposed to have a stipulated shape not further defined here.

EPS elements with an average diameter of 6 mm, which still contain a residual fraction of pentane, are chosen.

Initially, the still expandable EPS elements (Styropore spheres) are spray-coated with an aqueous polyvinyl alcohol solution and dried in an air stream at 60° C. This process feature is supposed to prevent the pentane still present from escaping in the expanded polystyrene, but at least hampering it as a result of additional process steps.

Further coating with a mixture of a polymer matrix and powdered spinels from Mn—Zn-ferrites then occurs as ferrimagnetic material. A so-called slurry is prepared as starting material for subsequent spray coating. It consists of an aqueous dispersion of polyvinyl acetate and a polyisocyanate cross-linking agent, in which the powdered ferrimagnetic material is mixed. During spray-coating, the slurry must be permanently agitated, otherwise the ferrimagnetic particles decant and demixing occurs. The EPS elements coated in this way are dried in an air stream at 80° C. By water removal, the polymer matrix from polyvinyl acetate forms and glues the ferrimagnetic particles to each other. The optical absorption is achieved when the EPS element packing has a thickness of 50 mm and the coating on the individual EPS elements has a thickness of about 0.1 mm. The transmission is then no longer detectable at a packing density of 50 mm.

The prepared aqueous slurry consists of the following solid fractions: 70 wt % Mn—Zn-ferrite powder with a particle size of <5 μm, 25 wt % polyvinyl acetate and polyisocyanate cross-linking agent and 5 wt % acetylene carbon black.

The coated EPS elements are then introduced to a closable mold, which is the negative of the molded article being produced. the coated EPS elements are exposed to water vapor in the mold, having a temperature of 115° C. (the usual range lies between 100 and 130° C.). Heat input means that the EPS elements become elastic and are inflated by the increasing pentane vapor pressure, the still open porosity is eliminated and the contact surfaces of the EPS element are enlarged. The hot water vapor also means that the polymer matrix and the barrier layer from polyvinyl alcohol becomes elastic and partially detaches, so that inflation of the EPS element is not adversely affected. The compressed coated EPS elements are glued to each other by means of the polymer under the deformation pressure. The polyisocyanate cross-linking agent is calculated so that the polymer matrix is only partially dissolved in the hot water vapor and remains elastic.

The entire packing of coated EPS elements is then dried in the mold at 100° C. and the finished absorber can be removed from the mold.

FIG. 1 shows as an example for an absorber produced according to the method the reflection coefficients as a function of frequency with non-detectable transmission. The incident radiation powder was 10 mW. The packing thickness is 50 mm.

### Practical Example II

In practical example II, production of a flexible absorber is described, in which the coated EPS elements are arranged as a monolayer, and which can be used for frequencies of >15 GHz. The corresponding drawing in FIG. 2 shows a partial section through the absorber with the coated EPS elements positioned in the lattice support, before the EPS elements in a subsequent process step are inflated with water vapor at 125° C. and the open porosity between the honeycomb walls and the coated EPS elements is closed. Using the method, the absorber is constructed on an elastic lattice support 1 from plastic with a honeycomb structure. FIG. 2 also shows, with item number 2, an adhesive, the coated EPS element 3, the spherical cap 4 and the walls 5 of the lattice support 1.

EPS elements with an average diameter of 3.2 mm are chosen, which still contain a residual fraction of pentane and, as individual spheres, roughly fill up the hexagonal honeycomb opening, referred to their diameter.

Initially, the EPS spheres are spray-coated similar to practical example I with an aqueous polyvinyl alcohol solution and dried in an air stream at 60° C. Since absorption of electromagnetic waves with frequencies >15 GHz is involved, it is necessary to alter the polymer matrix and the ferrimagnetic material relative to practical example I. A so-called slurry is prepared as starting material for subsequent spray-coating. It consists of an aqueous dispersion of styrene-butadiene copolymers, in which the powdered ferrimagnetic material from Sr-ferrite as M-type is mixed. During spray-coating, the slurry must be permanently agitated, otherwise the ferrimagnetic material decants, despite the lower particle size relative to the practical example I and demixing occurs.

The EPS elements coated in this way are dried in an air stream at 80° C. By water removal, the polymer matrix forms from the styrene-butadiene copolymer and glues the ferrimagnetic particles or groups of agglomerated particles to each other. The optimal absorption, i.e., no transmission occurs, is achieved at frequencies >70 GHz, when the thickness of the coating on the individual coated EPS elements 3 is about 0.1 mm.

For production of the absorber, a so-called honeycomb is chosen as lattice support 1, which supports the structure of hexagonally packed monolayer. Honeycombs are honeycombed-shaped hexagonal structures of polyamide paper and have a dielectric constant of <2, also because of their limited weight. The honeycomb height is 1.5 mm, i.e., about 0.5-times the diameter of the employed EPS element. Before introduction of the coated EPS element, the hexagonal honeycomb openings are sprayed with a liquid, solvent-containing styrene-butadiene copolymer as adhesive 2. The coated EPS elements 3 are then pushed into the openings of the honeycomb, adhering glue 2 is pushed onto the faces of the honeycomb walls by the spheres in the wall area of the honeycomb. Because of the ratio honeycomb height/spherical diameter=about 0.5, part of the spherical element protrudes as cap surfaces 4 above the honeycomb height level and the monolayer surface necessary for absorption and diffuse reflection of the incoming rays is formed. The monolayer surface so configured therefore has no additional adhesive on the cap surfaces as required, since the adhesive 2 is always situated on the walls 5 of the honeycomb.

In a continuation of the method according to the invention, the lattice support is introduced with the inserted monolayer of coated EPS elements into a closable container, which serves to introduce water vapor with a temperature of 125° C. through the open porosity between the coated EPS elements and the honeycomb walls. As in practical example I, the residual fraction of pentane in the coated EPS elements means that they are inflated, pressed against the honeycomb wall and glued to it. The protruding caps mutually approach each other as a result of the diameter expansion, so that the “visible” part of the honeycomb connectors for the radiation reaches a minimal value even in the worst case, when the electromagnetic radiation reaches the monolayer at right angles to the honeycomb surface. The glue situated on the honeycomb wall prevents the previously assumed initial position within the honeycomb lattice from being maintained. The absorber can then be removed from the closable container and dried in an air stream at 110° C.

The absorber is extremely flexible and in use can be readily adapted to the process devices and can be used from 70 GHz.

The aforementioned absorber with a monolayer of coated EPS elements 2 on a lattice support 1 can be slightly modified, if the frequency in use lies between 15 and 70 GHz, by arranging two layers of coated EPS elements with a correspondingly larger honeycomb height or, similar to the application of example I, by positioning an additional spherical packing, but with the polymer matrix and the ferrimagnetic material according to practical example I on the side of the monolayer facing away from the incoming rays.

1. Method for production of an absorber for microwaves, consisting of a packing of expanded polystyrene elements (EPS elements), on which a coating of ferrimagnetic particles is applied, characterized by the fact that
EPS elements with a residual fraction of pentane are chosen,
an aqueous polyvinyl alcohol solution is applied and then dried in an air stream at 60° C., so that an enclosure of synthetic polymer is formed, which prevents diffusion of pentane at temperatures lower than 100° C.,
application of a mixture of an aqueous dispersion of copolymers and ferrimagnetic particles,
drying of the coated EPS elements, so that the applied mixture is converted to a polymer matrix, in which the ferrimagnetic particles are embedded,
introduction of the coated EPS elements to a mold stipulated by the process, and
introduction of a water vapor stream with a temperature above 100° C. into the mold, so that the EPS elements assume their final size and shape through the vapor pressure of the residual pentane fraction.

2. M Method according to claim 1, characterized by the fact that a polyvinyl acetate with a polyisocyanate cross-linker, an aqueous anionic dispersion of a carboxylated styrene-butadiene copolymer of a finely dispersed aqueous dispersion of an acrylic acid ester-styrene copolymer, having an anionic emulsifier system is used as aqueous dispersion of copolymers.

3. Method according to claim 1, characterized by the fact that the mixture of aqueous dispersion of copolymers and ferrimagnetic particles is produced from the following solid fractions: 5-40 wt % polymer, 2-5 wt % acetylene carbon black and 93-55 wt % ferrimagnetic particles.

4. Method according to claim 1, characterized by the fact that EPS particles with a shape and a diameter from 0.5 to 10 mm are chosen as EPS elements.

5. Method according to claim 1, characterized by the fact that ferrimagnetic powder with a particle size of 200 nm to 15 μm is chosen as ferrimagnetic powder.

6. Absorber for microwaves, produced with a method according to claim 1, consisting of a packing of EPS elements, coated with a ferrimagnetic powder within a polymer matrix, and whose outer structure corresponds to a processing mold.

7. MAbsorber according to claim 6, characterized by the fact that the absorber has flat lattice support (1) of angled or tubular honeycombs, in which the EPS elements (3), which are coated with a ferrimagnetic powder within a polymer matrix are glued in at least one monolayer.

8. Absorber according to claim 6, characterized by the fact that the absorber is an element for reducing the weight and/or heat conductivity or increasing the sound absorption capacity of an end product.
